(19) United States
(12) Patent Application Publication
(10) Pub. No.: US 2026/0093565 A1
(43) Pub. Date: Apr. 2, 2026

(54) SYSTEMS AND METHODS FOR PERFORMING BUSINESS CRITICALITY WEIGHT-BASED AUDITS IN EDGE ENVIRONMENTS

(71) Applicant: Dell Products L.P., Round Rock, TX (US)

(72) Inventors: BORIS SHPILYUCK, Ashdod (IL); MAXIM BALIN, Gan-Yavne (IL); IGOR DUBROVSKY, Beer Sheva (IL); STAV SAPIR, Beer Sheva (IL)

(21) Appl. No.: 18/899,250

(22) Filed: Sep. 27, 2024

(51) Int. Cl. G06F 9/54

(52) U.S. Cl. CPC G06F 9/547

(57) ABSTRACT

Methods and systems for managing operation of a distributed system are disclosed. The operation of the distributed system may be managed by implementing auditing policies that selectively store audit information for functions of top level application programming interfaces based on a quantified level of importance of the corresponding applications. Each auditing policy may be keyed to at least one classification (corresponding to different levels of importance) and may include auditing procedures to obtain selective audit data when functions of top level application programming interfaces are invoked. The selective audit data may be used to resolve potential issues impacting the distributed system. Thus, more resources of the distributed system may be allocated for providing desired computer implemented services while being likely to include sufficient data to audit the operation of higher impact portions of the distributed system.

### FIELD

Embodiments disclosed herein relate generally to operations management. More particularly, embodiments disclosed herein relate to systems and methods to manage operations of distributed systems.

### BACKGROUND

Computing devices may provide computer implemented services. The computer implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows an interaction diagram in accordance with an embodiment.

FIG. 2B shows a diagram illustrating application programming interface call chains in accordance with an embodiment.

FIG. 2C shows a diagram illustrating data flows in accordance with an embodiment.

FIG. 3 shows a flow diagram illustrating a method of managing operation of a distributed system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a distributed system. To provide various computer-implemented services, information from a distributed system may need to be distributed to locations where the data is processed and/or otherwise used.

To facilitate data distribution, application programming interfaces (APIs) may be utilized. The APIs may facilitate distribution of information through invocation of functions of the APIs. To read data, for example, a function of an API may be invoked and enable the API to identify relevant data and provide the relevant data in response to the request.

To identify a potential problem with a computing device (e.g., more specifically an application of the computing device) of the distributed system, information regarding operation of the applications may be stored. The information for operations of applications may include information for an API call chain corresponding to an invocated function. The API call chain may include a series of API calls that are activated when a function of a top level API is activated. The API call chain information may be used to identify a vulnerability of an API within the API call chain.

However, for distributed systems that contain many services (e.g., provided by various different API's), allocating computer resources to store diagnostic data for API call chains may consume a large amount of computing resources and/or reduce the amount of computer resources to provide the computer implemented services. In addition, perform auditing processes (e.g., using the diagnostic data) may be computationally expensive and result in insufficient audit processes. For example, such limitations for storing all API call chains corresponding to invocation of a function of an API make it difficult for a user and/or entity to identify an issue with an API that places it in a vulnerable state.

To provide such an improved method for managing limited computing resources allocated for audit data, an audit management system having access to an audit policy management service (also referred to herein as a “audit data repository”) may be provided. Using the information stored in the audit policy management service, the audit management system may be able to identify auditing policies governing respective functions and selectively store audit data (also referred to herein as “auditing information”) for the functions of top level APIs based on classifications corresponding to levels of importance of the functions. The levels of importance for the functions may be quantifications based on weights ascribed to different APIs in each API call chain and the weights ascribed to different API's may vary between different entities and/or organizations based on their respective goals and/or regulations regarding data used for different API's.

Thus, embodiments disclosed herein may address, among others, the technical problem of limited computing resources within a distributed system. By storing audit data for select API call chains based on classifications corresponding to levels of importance, less useful audit data for relevantly less consequential functions of API's may be stored. Accordingly, the limited computing resources of the distributed system may be preferentially used to complete audit requests instead of storing inconsequential audit data for API's, which results in a technical improvement in the use and management of the computer devices'(e.g., the computing devices making up the distributed system).

In an embodiment, a method for managing operation of a distributed system is provided. The method may include: identifying a function invocation of a function of a top level application programming interface hosted by the distributed system; identifying an auditing policy that governs the function, the auditing policy being keyed to at least one classification of classifications for functions of the top level application programming interface, the classifications corresponding to levels of importance of the functions based on application programming interface call chains that are run when corresponding ones of the functions are invoked; recording, based on the auditing policy, auditing information for other functions of other application programming interfaces that are invoked due to the function invocation; using the auditing information to resolve an issue impacting the distributed system to obtain an updated distributed system; and providing computer implemented services using the updated distributed system.

The levels of importance of the functions may be quantifications based on weights ascribed to different application programming interfaces in each application programming interface call chain.

A quantification of the quantifications may be, for a given function of the functions, based on a highest weight ascribed to any of the application programming interfaces in a corresponding one of the application programming interface call chains for the function.

The auditing policy may specify, at least, types of information regarding the application programming interfaces that are to be recorded.

The auditing policy further may specify, at least, sampling frequencies for invocations of the function.

The auditing policy further may specify, at least, limits on quantities of information to be stored for the invocations of the function.

Using the auditing information to resolve the issue may include: identifying an application associated with the issue; screening the auditing information to identify a portion of the auditing information associated with the application; and using the portion of the auditing information to identify a modification for the application.

The method may include: screening other auditing information for an invocation of another function of the top level application programming interface to identify a second portion of the other auditing information associated with the application, wherein the second portion may be also used to identify the modification.

The top level application programming interface and the other application programming interfaces may be part of a service architecture in which any of the application programming interfaces of the service architecture may be adapted to make calls to each other to provide participate in provisioning of the computer implemented services.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

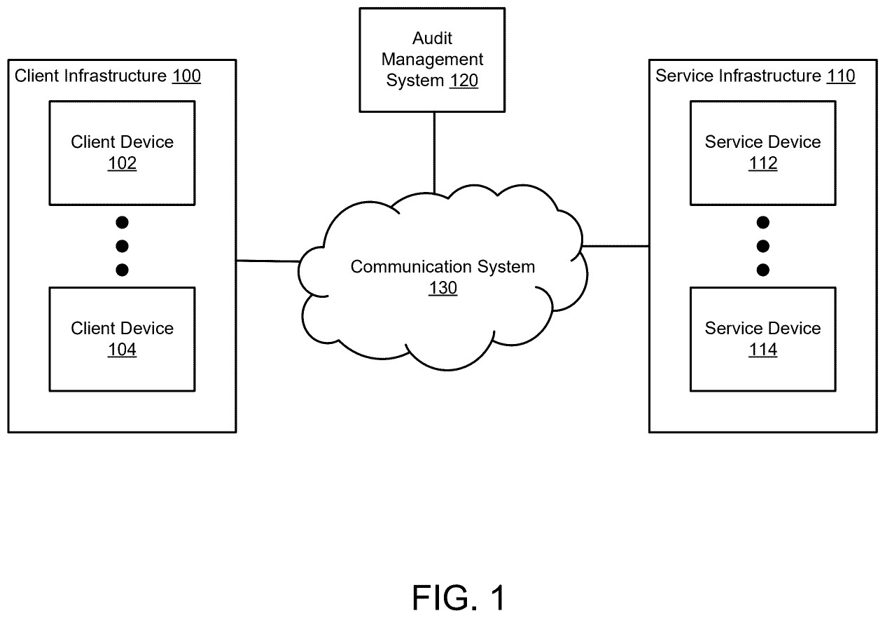

Turning to FIG. 1, a block diagram illustrating a system in accordance with an embodiment is shown. The system shown in FIG. 1 may provide computer implemented services. The computer implemented services may include any type and quantity of computer implemented services. For example, the computer implemented services may include data storage services, instant messaging services, database services, and/or any other type of service that may be implemented with a computing device.

To provide the computer implemented services, workloads may be performed by various components of the system. To perform the workloads, various information may need to be obtained. Similarly, when workloads are performed various types of new information may become available for use.

The information (e.g., resources) used in the workloads may be available from various devices of the system. To facilitate management of this information, any of the devices of the system may host instances of application programming interfaces (APIs). The APIs may be used by other devices and/or applications (e.g., hosted by other or the same device) to obtain data that may include information usable in workloads. APIs may also be used to set, change, and/or configure data (e.g., write to one or more services and/or resource providers).

In order to perform some workloads, invoking a function of a top level API (e.g., first API call in a chain of API calls) may invoke subsequent functions of other APIs (e.g., API call chains). For example, invoking a function of an API of one application (e.g., instant messaging application) may cause activation of other APIs of different applications in order to resolve the function invoked in the top level API corresponding to the instant messaging application and thereby, provide the desired computer implemented services.

When performing workloads, a computer system may be subject to issues that may impact integrity and/or security of data used during activation of API's. To identify and/or manage potential issues when performing workloads, information regarding operation of the computing system may be stored. For example, during operation of the computing system, information (e.g., audit data) for each API call chain activated may be recorded and stored (e.g., in storage resources of the computing system). However, storing information for an API call chain may consume a large amount of storage resources. For example, invoking a top level function of an API may result in a thousand API calls in an API call chain.

Even in the event of copious amounts of storage resources were available to store the information (e.g., audit data) for each API call chain, performing auditing processes of these large data structures may be computationally expensive and/or reduce amount of limited computing resources available to perform computer implemented services. By allocating computing resources to manage operation of the computing system (e.g., perform maintenance services), the amount of computing resources available to provide the computer implemented services (e.g., perform services to users of the computing system) may be reduced.

In general, embodiments disclosed herein may provide methods, systems, and/or services for managing operation of a distributed system. To manage operation of the distributed system, auditing policies may be utilized in selectively store audit data for functions of top level APIs based on a quantified level of importance of the corresponding applications.

To identify the auditing policy that governs a function of a top level API, each API call in an API call chain (e.g., invoked by the function of the top level API) may be evaluated based on a predetermined criticality weight ascribed to each API. The highest criticality weight of an API in the corresponding API call chain may be identified and used to classify a level of importance for the function of the top level API in the API call chain. Each auditing policy may be keyed to at least one classification and may include auditing procedures to obtain selective audit data when functions of top level APIs are invoked. The selective audit data may be used to resolve potential issues impacting the distributed system. Thus, the likelihood of audit data for higher impacting applications for respective users may be increased and as a result, may decrease the likelihood of storing audit data for less impactful applications.

In this manner, more resources of the distributed system may be allocated for providing desired computer implemented services while still being likely to include sufficient data to audit the operation of higher impact portions of the distributed system. Thus, a system in accordance with an embodiment may more efficiently marshal limited computing resources for providing desired computer implemented services by reducing the amount of computing resources used for other endeavors.

To provide for the above noted functionality, the system of FIG. 1 may include client infrastructure 100, service infrastructure 110, audit management system 120 and communication system 130. Each of these components is discussed below.

Client infrastructure 100 may provide desired computer implemented services. To do so, client infrastructure 100 may include any number of client devices (e.g., 102-104). The client devices may provide the computer implemented services cooperatively and/or individually.

To provide the computer implemented services, the client device may utilize information maintained by service infrastructure 110. To do so, the client devices may (i) invoke APIs hosted by service infrastructure 110 to obtain data, and (ii) use the obtained data to provide the computer implemented services.

Service infrastructure 110 may provide access to information used in the computer implemented services (e.g., service infrastructure 110 may be configured as part of the distributed system). To do so, service infrastructure 110 may host APIs, databases, and/or other data structures usable to store and provide access to stored information. Additionally, service infrastructure 110 may include custom resource creation functionality through which custom resources may be established and used by other device to access data maintained by service infrastructure 110.

To provide its functionality, service infrastructure 110 may include any number of service devices (e.g., 112-114) (also referred to herein as “resource providers”). The services devices (or resource providers) may provide access to information (e.g., data, services, resources, or the like) cooperatively or individually.

To manage operation of the distributed system (e.g., any components of client infrastructure 100 and/or service infrastructure 110) when a potential issue impacts the distributed system, the system may include audit management system 120. Audit management system 120 may utilize auditing policies to selectively store audit data for functions of APIs and resolve potential issues impacting the distributed system using the audit data.

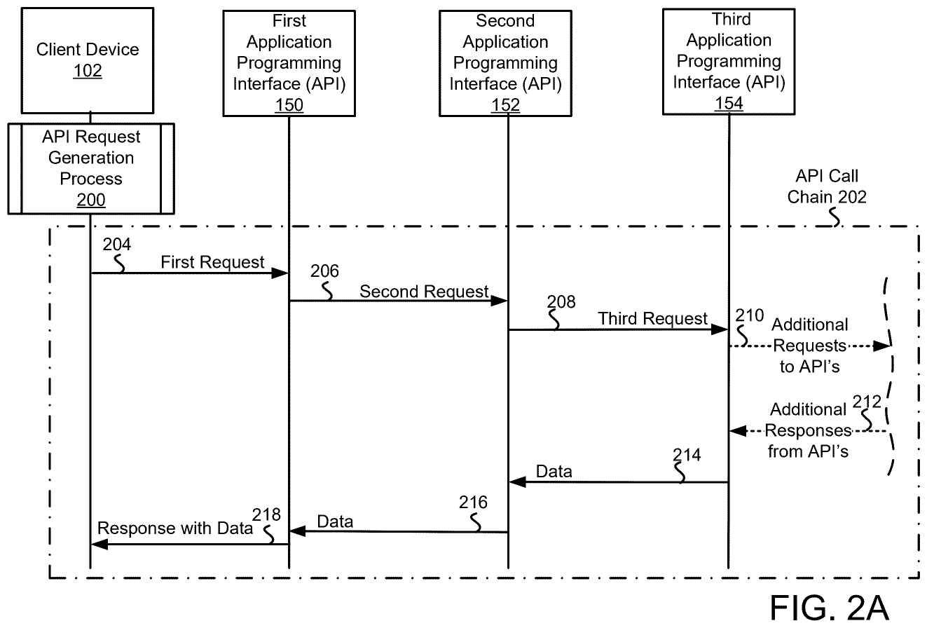

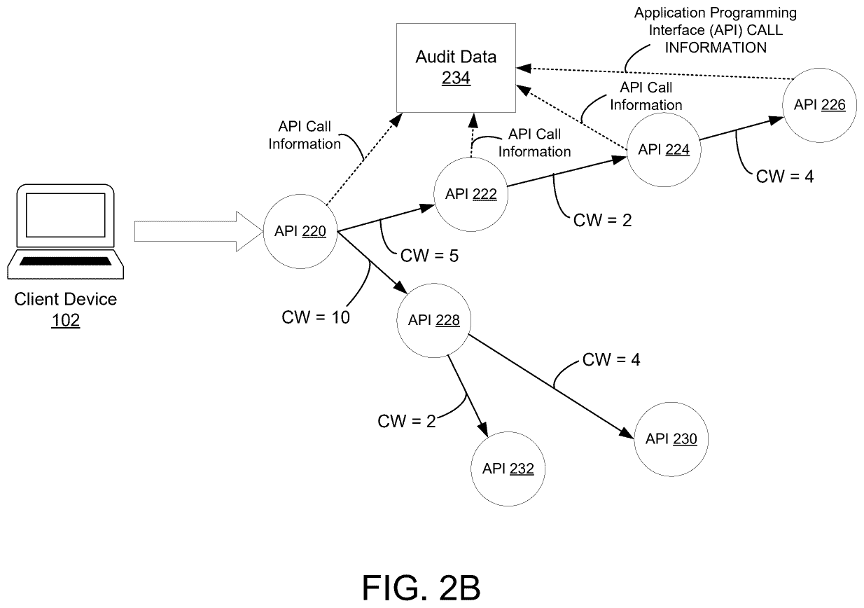

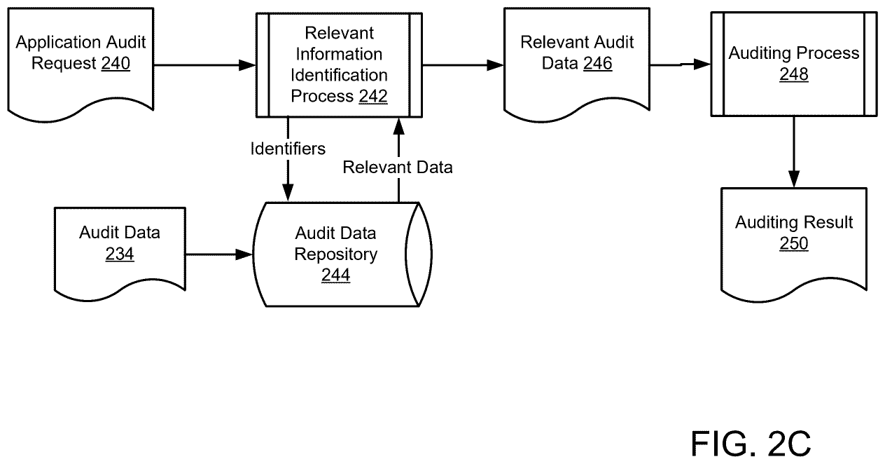

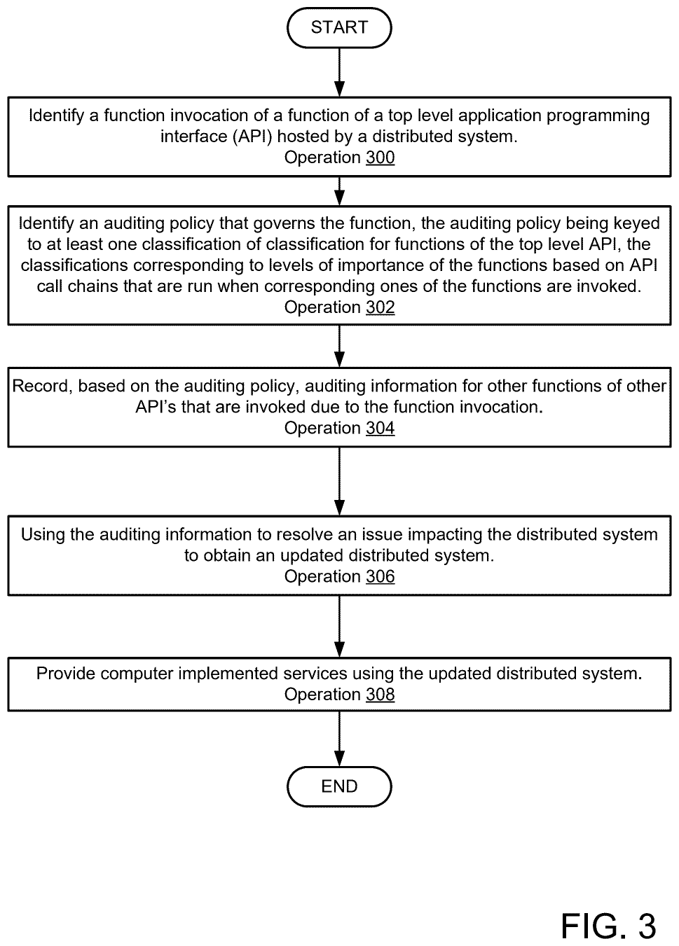

When providing their functionality, any of the components of the client infrastructure 100, service infrastructure 110, and/or audit management system 120 may perform the flows and methods illustrated in FIGS. 2A-3.

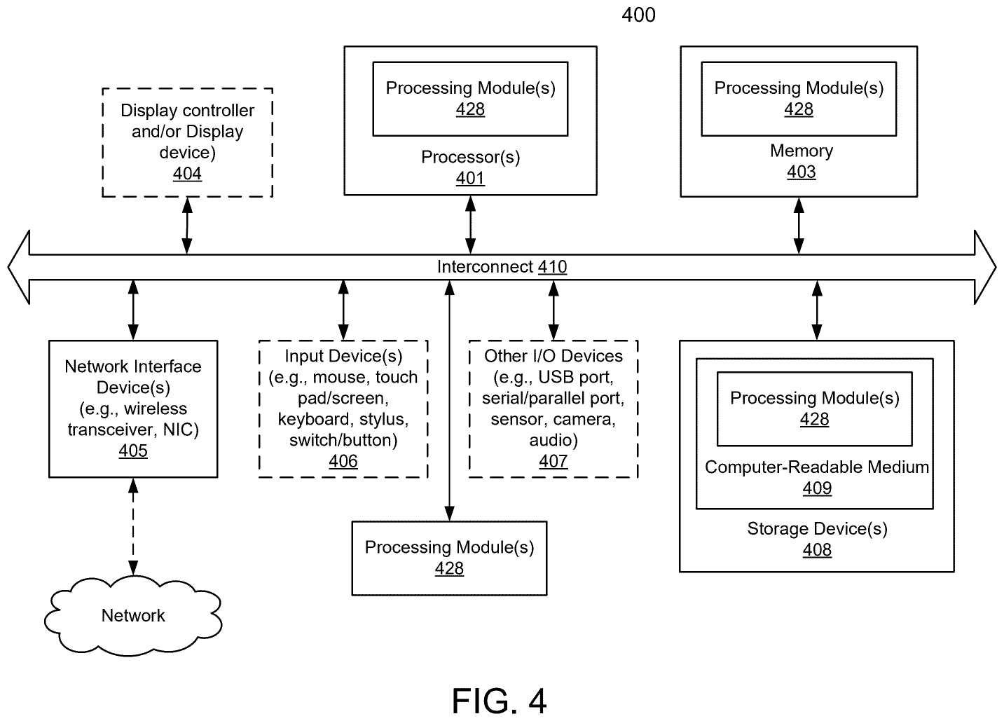

Each of the components of the client infrastructure 100 (e.g., the client devices 102-104), of the service infrastructure 110 (e.g., the service devices 112-114), and of audit management system 120 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Additionally, although audit management system 120 is shown as being a separate and/or remote device from client infrastructure 100 and/or service infrastructure 110, audit management system 120 may also be implemented as hardware, software, or a combination of both as part of each service device 112-114 and/or each client device 102-104. For example, an instance of the audit management system 120 may be installed in each of the client devices 102-104 and/or in each of the service devices 112-114.

Any of the components illustrated in FIG. 1 may be operably connected to each other (and/or components not illustrated) with communication system 130. In an embodiment, communication system 130 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, interaction diagram in accordance with an embodiment is shown in FIG. 2A. These interaction diagram may illustrate how data may be obtained and used within the system of FIG. 1.

In the interaction diagram, processes performed by and interactions between components of a system in accordance with an embodiment are shown. In the diagram, components of the system are illustrated using a first set of shapes (e.g., 150, 152, etc.), located towards the top of each figure. Lines descend from these shapes. Processes performed by the components of the system are illustrated using a second set of shapes (e.g., 200, etc.) superimposed over these lines. Interactions (e.g., communication, data transmissions, etc.) between the components of the system are illustrated using a third set of shapes (e.g., 204, 208, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 214 may occur prior to the interaction labeled as 216. However, it will be appreciated that the processes and interactions may be performed in different orders, any may be omitted, and other processes or interactions may be performed without departing from embodiments disclosed herein.

The lines extending between the components, the third set of shapes (e.g., 210, 212, etc.) is drawn in dashing to indicate, for example, that the corresponding interactions may not be (i) operable, (ii) present in the system, and/or (iii) not participating in operation of the system for other reasons.

The lines around the third set of shapes (e.g., 204, 218, etc.) are drawn in dashing with interspersed dots to indicate, for example, that the interactions between the components of the system may represent activity of an API call chain in the aggregate.

Turning to FIG. 2A, an interaction diagram in accordance with an embodiment is shown. The interaction diagram may illustrate processes and interactions that may occur during invocation of a function of a top level application programming interface (API).

To invoke the function of the top level API, client device 102 may perform API request generation process 200. During API request generation process 200, an API request may be generated by a client device 102. Alternatively, the API request may be obtained by the client device 102 from another sources (e.g., another client device).

At interaction 204, a first request may be provided to first API 150 by client device 102. For example, the first request may be provided to first API 150 via (i) transmission via a message, (ii) storing in a storage with subsequent retrieval by first API 150, (iii) via a publish-subscribe system where first API 150 subscribes to updates from client device 102 thereby causing a copy of the first request to be propagated to first API 150, and/or via other processes. By providing the first request to first API 150, first API 150 may provide API request management services.

Once received, first API 150 may require additional data in order to complete and/or perform the requested services specified in the first request. At interaction 206, a second request may be provided to second API 152 by first API 150. For example, the second request may be generated and provided to second API 152 via (i) transmission via a message, (ii) storing in a storage with subsequent retrieval by second API 152, (iii) via a publish-subscribe system where second API 152 subscribes to updates from first API 150 thereby causing a copy of the second request to be propagated to second API 152, and/or via other processes. By providing the second request to second API 152, second API 152 may provide API request management services (e.g., corresponding to second API 152).

Once received, second API 152 may require additional data in order to complete and/or perform the requested services specified in the second request. At interaction 208, a third request may be provided to third API 154 by second API 152. For example, the third request may be generated and provided to third API 154 via (i) transmission via a message, (ii) storing in a storage with subsequent retrieval by third API 154, (iii) via a publish-subscribe system where third API 154 subscribes to updates from second API 152 thereby causing a copy of the third request to be propagated to third API 154, and/or via other processes. By providing the third request to third API 154, third API 154 may provide API request management services (e.g., corresponding to third API 154).

Once received, third API 154 may require further additional data in order to complete and/or perform the requested services specified in the third request. For example, at interaction 210, additional requests to API's (e.g., fourth API, fifth API, etc.) may be generated and provided to other API's (e.g., fourth API, fifth API, etc.)

Conversely, after receiving the third request, third API 154 may identify relevant data and provide the relevant data in response to the request (e.g., the third request). Although this example specifically discusses the use of APIs for obtaining data, one of ordinary skill will appreciate that APIs may also be used for other functions such as, but not limited to, to set, change, and/or configure data (e.g., write to one or more services and/or resource providers).

At interaction 214, data may be provided to second API 152 by third API 154. For example, the data may be generated and provided to second API 152 via (i) transmission via a message, (ii) storing in a storage with subsequent retrieval by second API 152, (iii) via a publish-subscribe system where second API 152 subscribes to updates from third API 154 thereby causing a copy of the data to be propagated to second API 152, and/or via other processes. By providing the data to second API 152, second API 152 may utilize the data to service the second request and provide API request management services (e.g., corresponding to second API 152).

Similarly, to interaction 214, the data may be provided to first API 150 by second API 152 at interaction 216. By providing the data to first API 150, first API 150 may utilize the data to service the first request and provide API request management services.

At interaction 218, a response with data may be provided to client device 102 by first API 150. For example, the response with data may be generated by first API 150 and provided to client device 102 via (i) transmission via a message, (ii) storing in a storage with subsequent retrieval by client device 102, (iii) via a publish-subscribe system where client device 102 subscribes to updates from first API 150 thereby causing a copy of the response with data to be propagated to client device 102, and/or via other processes. By providing the response with data to client device 102, client device 102 may utilize the response with data to provide the desired computer implemented services.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, via processes and interactions shown in FIG. 2A, activation of a function of a top level application programming interface (API) may include activation of other functions of other API's which may be represented as an API call chain.

Turning to FIG. 2B, a diagram in accordance with an embodiment is shown. The diagram may include a graph illustrating relationships between components (e.g., APIs) supporting API call chains.

To obtain audit data usable to investigate operation of the components, functions of top level APIs may be classified based on an evaluation of API call chains that are run when corresponding functions are invoked. The classifications for each function of a top level API may correspond to a level of importance of the respective function.

To ascribe a level of importance to each function of a top level API, evaluation of each subsequent API calls in the API call chain may be performed. For example, API 220 may be a top level API which may have 3 example functions. When function 1 of API 220 is activated, a first API call chain may be activated. The first API call chain may include API 222, API 224, and/or API 226. For example, client device 102 may invoke function 1 of API 220 which may cause a first API call to API 222 (e.g., relating to a database), a second API call to API 224 (e.g., relating to instant messaging application), and then a third API call to API 226 (e.g., relating to an inference model program).

Similarly, when other functions of the top level API are activated (e.g., by client device 102) corresponding API call chains may be activated. For example, when function 2 of API 220 is activated, a second API call chain may be activated. The second API call chain may include API 228, and/or API 232. Likewise, when function 3 of API 220 is activated, a third API call chain may be activated. The third API call chain may include API 228, and/or API 230.

Each API may be assigned a business critical weight (otherwise referred to as criticality weight herein) to represent a level of criticality of the respective API to provide desired computer implemented services. The criticality weight assigned to each API may be established by an administrator, subject matter expert, and/or via automated processes. For example, a credit card servicing company may assign a higher criticality weight to API's that are part of a database application that stores financial data for clients and may assign a lower critically weight to API's that are part of an instant messaging program that provides a messaging platform to interact with clients.

For example, API 228 may be a financial database that stores financial data (e.g., reported yearly earnings, credit card information, etc.) for clients. Use of and/or consequences of unauthorized access to the financial data may be highly impactful for the credit card servicing company and as such, API 228 may be assigned a criticality weight of 10.Conversely, API 232 may be an instant messaging application that allows quick communication between an administrator of the credit card servicing company and one of their clients. Use of and/or consequences of unauthorized access to data used by API 232 may be less impactful (e.g., comparatively to the financial data utilized by API 228) to the credit card servicing company.

As noted above, each API call in an API call chain for a corresponding function of a top level API may be evaluated to determine the level of importance of the respective function. To do so, the highest criticality weight of an API call in the API call chain may be identified and used in a normalization process to obtain a quantifiable normalized criticality weight. For example, during the normalization process, the maximum criticality weight for each function may be divided by the highest criticality weight of the system (e.g., maximum criticality weight of all API call chains). For example, to obtain the normalized criticality weight for function 2, the maximum criticality weight for the second API call chain (e.g., 10) may be divided by the maximum criticality weight for the system (e.g., 10), resulting in a normalized criticality weight of 0.10.

As an additional example, to obtain the normalized criticality weight for function 1,the maximum criticality weight for the first API call chain (e.g., 5) may be divided by the maximum criticality weight for the system (e.g., 10), resulting in a normalized criticality weight of 0.10.

Once obtained, the normalized criticality weights for each function of a top level API may be used in a classification process to assign classifications to each function. During the classification process, various classification levels may be assigned to each function based on predetermined weight ranges. For example, the classifications may specify different levels of importance, such as, “critical” for functions with normalized criticality weights in the range of 0.7 to 0.10, “highly important” for functions with normalized criticality weights in the range of 0.5 to 0.7, and/or “moderate” for functions with normalized criticality weights in the range of 0.2 to 0.5.

The classifications assigned to each function may be used to identify a corresponding auditing policy that governs the function. Different auditing policies may include different auditing requirements and/or perform different auditing processes for obtaining audit data 234 based on the different levels of classifications. For example, when a function is invoked, the corresponding auditing policy may specify (i) types of information regarding the APIs that are to be recorded, (ii) sampling frequencies for invocations of the respective function, (iii) limits on quantities of information to be stored for the invocations of the function, and/or (iv) other information.

For example, an auditing policy for functions classified as “moderate” may include instructions to record information that the function was activation. Conversely, an auditing policy for functions classified as “highly important” may include instructions to record information regarding (i) when the function was activated, (ii) names of all data files used in the activation of the function, (iii) storage location of the data files, and/or (iv) other information.

As a result, audit data 234 may be stored (e.g., in storage resources of audit management system 120) and utilized to resolve potential issues that may impact operation of the distributed system. Refer to FIG. 2C for additional details regarding utilizing auditing information to manage operation of a distributed system.

To further clarify embodiments disclosed herein, data flow diagrams in accordance with an embodiment are shown in FIG. 2C. In these diagrams, flows of data and processing of data are illustrated using different sets of shapes. A first set of shapes (e.g., 240, 246, etc.) is used to represent data structures, a second set of shapes (e.g., 242, 248, etc.) is used to represent processes performed using and/or that generate data, and a third set of shapes (e.g., 244, etc.) is used to represent large scale data structures such as databases.

Turning to FIG. 2C, a data flow diagram in accordance with an embodiment is shown. The data flow diagram may illustrate data used in and data processing performed in auditing application data.

To audit application data, application audit request 240 may be generated by a client device 102. Alternatively, the application audit request may be obtained by the client device 102 from another sources (e.g., another client device).

In embodiments, application audit request 240 provided by the client device 102 may be ingested by relevant information identification process 242. Relevant information identification process 242 transforms the application audit request 240 into a common metadata framework (also referred to herein as “predefined standardized format”).

Relevant information identification process 242 may parse the application audit request to identify information usable for identifying the application in which is to be audited. The information for the application may be used as identifiers that are used to retrieve information associated with top level function of an API. Relevant information identification process 242 may be executed by any of the components (e.g., client devices 102-104, service devices 112-114, and/or audit management system 120, or the like) of FIG. 1.

Once obtained, the identifiers (e.g., for the application) may be used to perform a look up to identify relevant data stored in audit data repository 244. Audit data repository 244 may store audit data 234 (e.g., obtained via processes illustrated and described above in FIG. 2B) for functions of top level APIs (e.g., associated with corresponding applications). Audit data repository 244 may store audit data 234 in a searchable format that is keyed to functions of different applications such that when an identifier for a function of an API is used as a key in a look up process, all relevant data for an application (e.g., audit data 234 corresponding to the API) may be obtained.

Once obtained, as a result of relevant information identification process 242, the relevant data may be used to generate a data package including the auditing information for the application (e.g., relevant audit data 246). Relevant audit data 246 may include all audit data relevant to an application. For example, relevant audit data 246 may include information for each API call chain associated with the application including frequency in which functions of the top level API were invoked, storage location of data filed used in activation of each function, any inference models used as part of each activation, etc. Relevant audit data 246 may be used as part of auditing process 248 in order to identify and/or resolve potential issues relevant to the corresponding application.

Auditing process 248 may include ingesting relevant audit data 246. Once ingested, relevant audit data 246 may be subject to a parsing process to obtain auditing result 250. During auditing process 248, the relevant audit data 246 may be parsed through by an administrator and/or management entity that provides services using the respective application, via automated processes, and/or by other parsing methods.

Auditing result 250 may include any information identified as diagnostically relevant to resolve issues with the application. Auditing result 250 may be used to resolve the issues impacting the operation of the application and thereby, obtaining an updated distributed system. The updated distributed system may be used to provide the desired computer implemented services.

As discussed above, the components of FIGS. 1-2C may perform various methods to manage the operation of a distributed system. FIG. 3 illustrates methods that may be performed by the components of FIGS. 1-2C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a distributed system accordance with an embodiment is shown. The method may be performed by any of the components shown in FIG. 1.

At operation 300, a function invocation of a function of a top level application programming interface (API) hosted by a distributed system may be identified. The function invocation may be identified by (i) receiving an API request from a computing device (e.g., client device 102), (ii) identifying the function to invoke based on the API request, and/or (iii) by any other methods.

At operation 302, an auditing policy that governs the function may be identified. The auditing policy may be identified by (i) obtaining identifiers for the function usable to identify the invoked function, (ii) performing a look up using the identifiers as a key to identify, at least, one classification of classifications corresponding to the function, (iii) identifying the auditing policy based on the identified classification(s), and/or (iv) by any other methods.

At operation 304, auditing information for other functions of other API's that are invoked due to the function invocation may be recorded. The auditing information may be recorded by (i) obtaining, based on the auditing policy, instructions regarding the audit information to record (e.g., types, sampling frequency (e.g., for invocation of the function), limits on quantities of information to be stored, and/or other information), (ii) facilitating storage of the auditing information for the function according to the instructions, and/or (iii) by any other methods.

At operation 306, the auditing information may be used to resolve an issue impacting the distributed system to obtain an update distributed system. The auditing information may be used by (i) identifying an application associated with the issue, (ii) screening the auditing information to identify a portion of the auditing information associated with the application, and/or (iii) using the portion of the auditing information to identify a modification for the application.

The method may also include: screening other auditing information for an invocation of another function of the top level application programming interface to identify a second portion of the other auditing information associated with the application. The second portion is also used to identify the modification.

At operation 308, computer implemented services may be provided using the updated distributed system. The computer implemented services may be provided by (i) obtaining the updated distributed system, (ii) performing the computer implemented services with the updated distributed system, and/or (iii) any other methods.

Thus, using the method illustrated in FIG. 3, embodiments disclosed herein may facilitate obtaining user input and using the user input to provide computer implemented services. By obtaining the user input via a passive device (at least with respect to user input), a human interface device in accordance with embodiments disclosed herein may be of lower complexity thereby improving the likelihood of continued operation, may not be dependent on power sources, may not require as large of physical loads to be exerted by users, and may provide other benefits.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a distributed system, the method comprising:
identifying a function invocation of a function of a top level application programming interface hosted by the distributed system;
identifying an auditing policy that governs the function, the auditing policy being keyed to at least one classification of classifications for functions of the top level application programming interface, the classifications corresponding to levels of importance of the functions based on application programming interface call chains that are run when corresponding ones of the functions are invoked;
recording, based on the auditing policy, auditing information for other functions of other application programming interfaces that are invoked due to the function invocation;
using the auditing information to resolve an issue impacting the distributed system to obtain an updated distributed system; and
providing computer implemented services using the updated distributed system.

2. The method of claim 1, wherein the levels of importance of the functions are quantifications based on weights ascribed to different application programming interfaces in each application programming interface call chain.

3. The method of claim 2, wherein a quantification of the quantifications is, for a given function of the functions, based on a highest weight ascribed to any of the application programming interfaces in a corresponding one of the application programming interface call chains for the function.

4. The method of claim 1, wherein the auditing policy specifies, at least, types of information regarding the application programming interfaces that are to be recorded.

5. The method of claim 4, wherein the auditing policy further specifies, at least, sampling frequencies for invocations of the function.

6. The method of claim 5, wherein the auditing policy further specifies, at least, limits on quantities of information to be stored for the invocations of the function.

7. The method of claim 1, wherein using the auditing information to resolve the issue comprises:
identifying an application associated with the issue;
screening the auditing information to identify a portion of the auditing information associated with the application; and
using the portion of the auditing information to identify a modification for the application.

8. The method of claim 7, further comprising:
screening other auditing information for an invocation of another function of the top level application programming interface to identify a second portion of the other auditing information associated with the application,
wherein the second portion is also used to identify the modification.

9. The method of claim 1, wherein the top level application programming interface and the other application programming interfaces are part of a service architecture in which any of the application programming interfaces of the service architecture are adapted to make calls to each other to provide participate in provisioning of the computer implemented services.

10. A non-transitory machine-readable medium having instructions stored therein, which when executed by a processor, cause the processor to perform operations for managing operation of a distributed system, the operations comprising:
identifying a function invocation of a function of a top level application programming interface hosted by the distributed system;
identifying an auditing policy that governs the function, the auditing policy being keyed to at least one classification of classifications for functions of the top level application programming interface, the classifications corresponding to levels of importance of the functions based on application programming interface call chains that are run when corresponding ones of the functions are invoked;
recording, based on the auditing policy, auditing information for other functions of other application programming interfaces that are invoked due to the function invocation;
using the auditing information to resolve an issue impacting the distributed system to obtain an updated distributed system; and
providing computer implemented services using the updated distributed system.

11. The non-transitory machine-readable medium of claim 10, wherein the levels of importance of the functions are quantifications based on weights ascribed to different application programming interfaces in each application programming interface call chain.

12. The non-transitory machine-readable medium of claim 11, wherein a quantification of the quantifications is, for a given function of the functions, based on a highest weight ascribed to any of the application programming interfaces in a corresponding one of the application programming interface call chains for the function.

13. The non-transitory machine-readable medium of claim 10, wherein the auditing policy specifies, at least, types of information regarding the application programming interfaces that are to be recorded.

14. The non-transitory machine-readable medium of claim 13, wherein the auditing policy further specifies, at least, sampling frequencies for invocations of the function.

15. The non-transitory machine-readable medium of claim 14, wherein the auditing policy further specifies, at least, limits on quantities of information to be stored for the invocations of the function.

16. A data processing system comprising:
a processor; and
a memory, wherein the memory stores instructions that when executed by a processor cause the processor to perform operations for managing operation of a distributed system, the operations comprising:
identifying a function invocation of a function of a top level application programming interface hosted by the distributed system;
identifying an auditing policy that governs the function, the auditing policy being keyed to at least one classification of classifications for functions of the top level application programming interface, the classifications corresponding to levels of importance of the functions based on application programming interface call chains that are run when corresponding ones of the functions are invoked;
recording, based on the auditing policy, auditing information for other functions of other application programming interfaces that are invoked due to the function invocation;
using the auditing information to resolve an issue impacting the distributed system to obtain an updated distributed system; and
providing computer implemented services using the updated distributed system.

17. The data processing system of claim 16, wherein the levels of importance of the functions are quantifications based on weights ascribed to different application programming interfaces in each application programming interface call chain.

18. The data processing system of claim 17, wherein a quantification of the quantifications is, for a given function of the functions, based on a highest weight ascribed to any of the application programming interfaces in a corresponding one of the application programming interface call chains for the function.

19. The data processing system of claim 16, wherein the auditing policy specifies, at least, types of information regarding the application programming interfaces that are to be recorded.

20. The data processing system of claim 19, wherein the auditing policy further specifies, at least, sampling frequencies for invocations of the function.
